(19) United States
(12) Patent Application Publication
(10) Pub. No.: US 2012/0075571 A1
(43) Pub. Date: Mar. 29, 2012

(54) Decorative arm sleeves for eyeglasses

(76) Inventor: Max Silver, Woodway, TX (US)

(21) Appl. No.: 12/924,228

(22) Filed: Sep. 23, 2010

(51) Int. Cl. G02C 11/02

(52) U.S. Cl. 351/52

(57) ABSTRACT

An eyeglass frame system includes a lens frame, a planar side extension pivotally attached at opposite ends of the lens frame, and an integrated earpiece and temple frame, an end opposite to the earpiece portion including an elongate longitudinal channel complemental in cross-sectional geometry to that of the planar side pivotally attached to the lens frame. The temple and earpiece frame may be selectably inserted over the side extension.

### BACKGROUND OF THE INVENTION

The present invention relates generally to the field of eyeglasses and sunglasses worn for recreational and other activities. More particularly, this invention pertains to foldable eyeglass frames having selectable decorative ornamentation displayed on the temple pieces of the frame.

It is known in the prior art to embellish such eyeglass frames by providing decorative elements on the side pieces, such side pieces herein termed temple frames. It is also known in the art to select eyeglass frames according to their decorative elements so as to match the graphics of apparel worn by the user or of particular interests to the user.

As examples, U.S. Pat. No. 6,652,093 and PCT Publications WO 98/23994, WO 97/44699 and WO 09/052,705 each describe an eyeglass frame structure comprising a decorative element of a temple frame that is mounted in a manner such that the decorative element can rotate or slide with respect to fixed parts of the temple frame. For various reasons, the structures taught therein are not cost-effective, durable, or convenient to use.

Additionally, U.S. Pat. No. 2,842,028 teaches a plastic eyeglass frame having strengthening or decorative inlays permanently fixed into a rectangular cut channel disposed in a temple frame by adhesive.

U.S. Pat. No. 5,033,836 describes an eyeglass frame including a lens frame, having replaceable ornamental lateral extensions to which the temple frame is attached by a hinge.

U.S. Pat. No. 4,958,923 teaches a system in which the temple pieces may be slip-or-pressure-fit over extension elements from the eyeglass frame. However, such temple pieces are not proportioned for ease of removal from or re-attachment to the extension elements of the eyeglass frame.

U.S. Pat. No. 7,261,409 elaborates the teaching of U.S. Pat. No. 6,652,093 in which a decorative element is axially secured within a longitudinal outer channel of a temple piece.

One disadvantage of these prior art eyeglass frames is the inability to readily interchange decorative designs in or of the temple frames. Users concerned with using eyeglasses as a fashion accessory consider this a significant shortcoming of the prior art, requiring the purchase of additional eyeglass frames for the users to effectively coordinate their decorative eyeglasses with their multiple pieces of apparel.

What therefore is lacking in the art is an eyeglass frame with rapidly interchangeable decorative inserts or portions that can be readily installed upon and removed from the temple frame without the use of tools other than the user's hands, which forms a part of the temple frame itself, or in which the temple frame itself may be easily changed. Such decorative inserts, elements, or frames preferably comprise separate, inexpensive and interchangeable parts available in a wide variety of decorative patterns, textures, colors or other selectable variable ornamental features.

### SUMMARY OF THE INVENTION

The present decorative eyeglass frame system includes a lens frame, a pair of integrated temple and earpieces, each having a proximal end pivotably attachable to opposing sides of the lens frame, at least one member of said pair of temple pieces having a longitudinal channel integrated into an outer side of a temple portion thereof, said channel having at least one open end. The system further includes a selectable decorative insert, at least a portion of an inner side thereof having a longitudinal male portion having a transverse cross-section substantially complemental in transverse cross-section to said longitudinal channel of said at least one temple piece. The insert includes an outer surface upon which a decorative expression or icon may be applied or otherwise integrated.

In a second embodiment of the invention, the temple frame comprises two parts, a forward part of which is pivotally attached to an end of the eyeglass frame and an earpiece portion which includes a longitudinal aperture complemental in transverse cross-section to the geometry of said forward part of the temple frame. In this embodiment, the earpiece portion of the temple frame is provided with an ornamental expression, icon or peripheral geometry of interest to the user. Therein, a plurality of ear portions of the temple frame may be purchased in a package or group of designs fashion of interest to the user. That is, a plurality of ear portions of the temple frame may be purchased in a package or group fashion by a buyer of the inventive system.

It is therefore an object of this invention to provide a system for decorating a temple piece of an eyeglass frame and providing a sturdy and removably engaging affixed of the decorative portion to the temple piece of an eyeglass frame system.

A further object is to provide a means for decoration of an eyeglass frame system in which the integration of the decorative portion may be accomplished by a pressure fit engagement between respective portions of the temple piece and an extension of the eyeglass frame.

Further objects, features and advantages of the present invention will become apparent from the hereinafter specification and claims considered in connection with the accompanying drawings, illustrating the preferred embodiment of the invention.

### DETAILED DESCRIPTION OF THE DRAWINGS

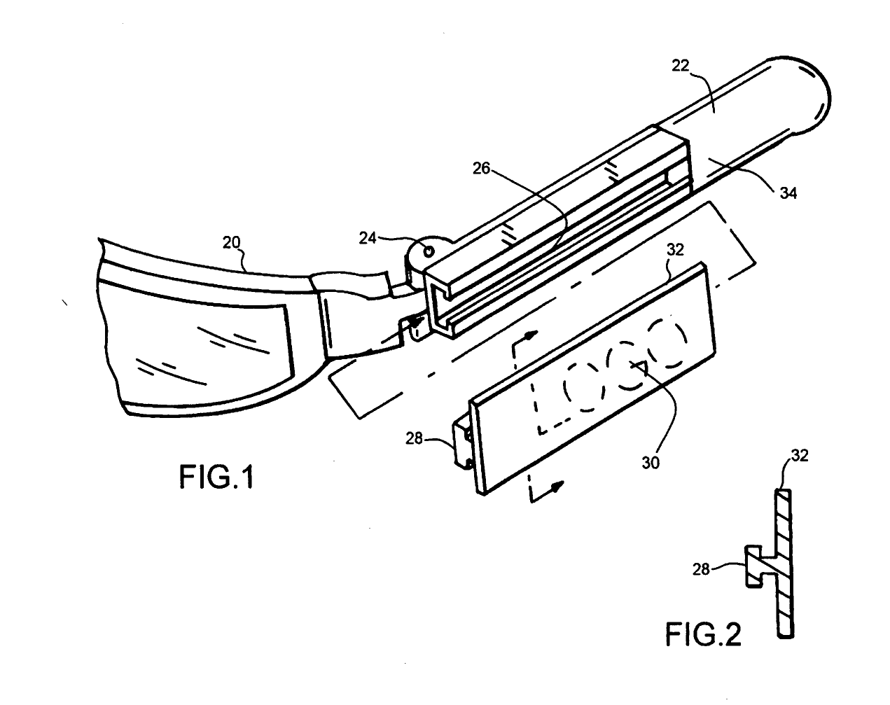

FIG. 1 is an exploded view of a first embodiment of the invention showing the decorative element of the temple piece prior to insertion of the decorative element associated therewith.

FIG. 2 is a cross-sectional view of a decorative element taken along Line 2-2 of FIG. 1.

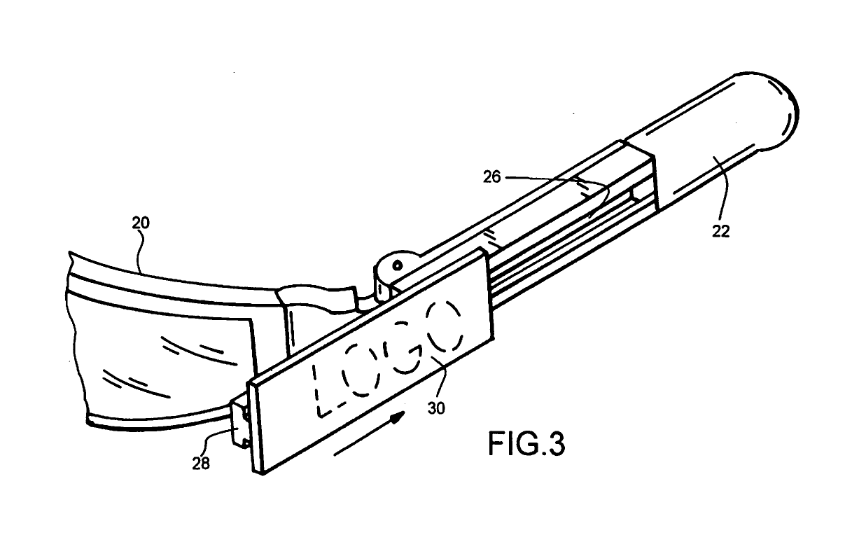

FIG. 3 is a view, sequential to FIG. 1, showing the decorative element of the present system partially inserted into its complemental track formed within the temple frame of the eyeglass system.

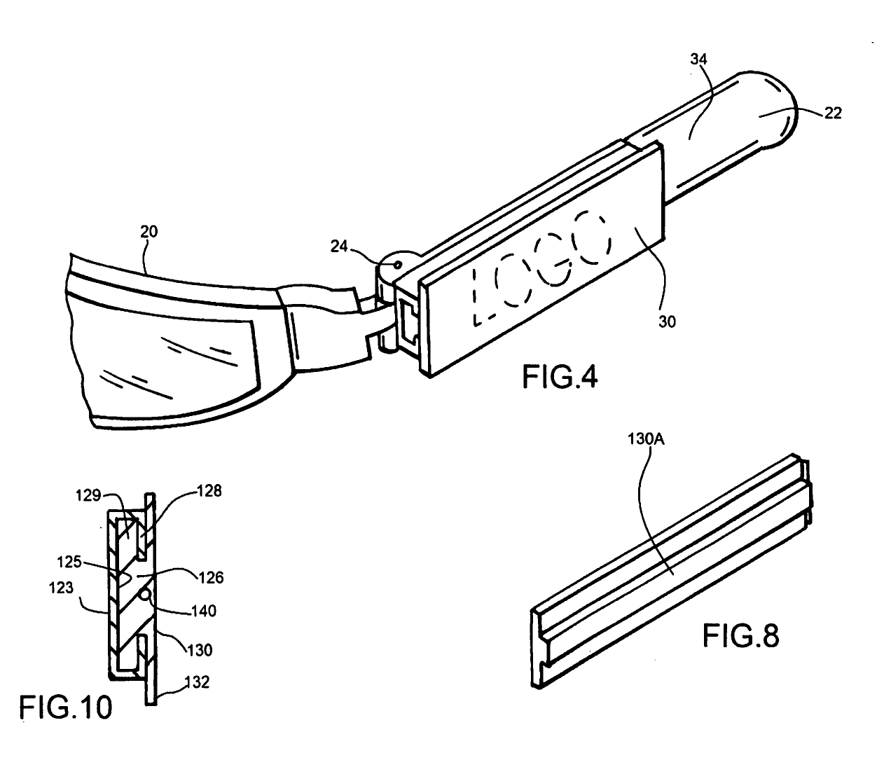

FIG. 4 is a view, sequential to FIG. 3, showing the complete insertion of the decorative portion into the temple frame of the eyeglass system.

FIG. 5 is an exploded view of a second embodiment of the inventive system in which the insert element thereof has not yet been inserted into the temple frame.

FIG. 6 is a view, sequential to FIG. 5, showing the partial insertion of the ornamental element into the temple frame.

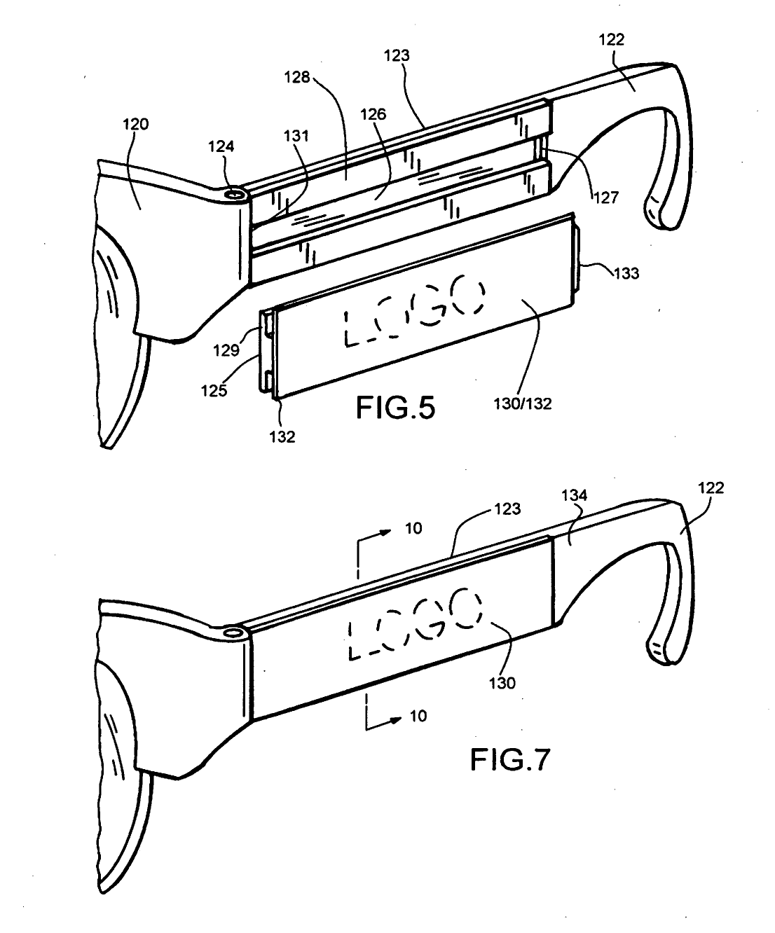

FIG. 7 is an assembly view, sequential to that of FIG. 6, showing the complete insertion of the decorative element into the temple frame of the system.

FIG. 8 is a perspective view of further variation of the insert of FIGS. 5-7.

FIG. 9 is a perspective view of further embodiments of the decorative insert.

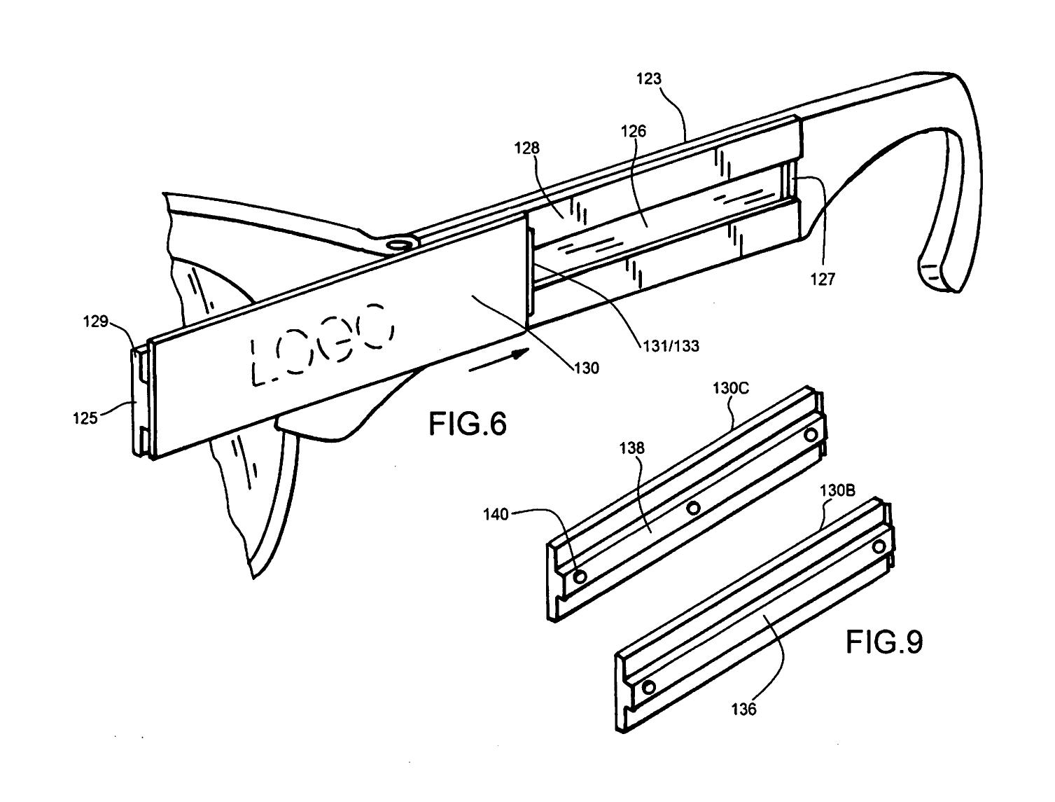

FIG. 10 is a cross-sectional view of the insert element in combination with a temple frame taken along Line 10-10 of FIG. 7.

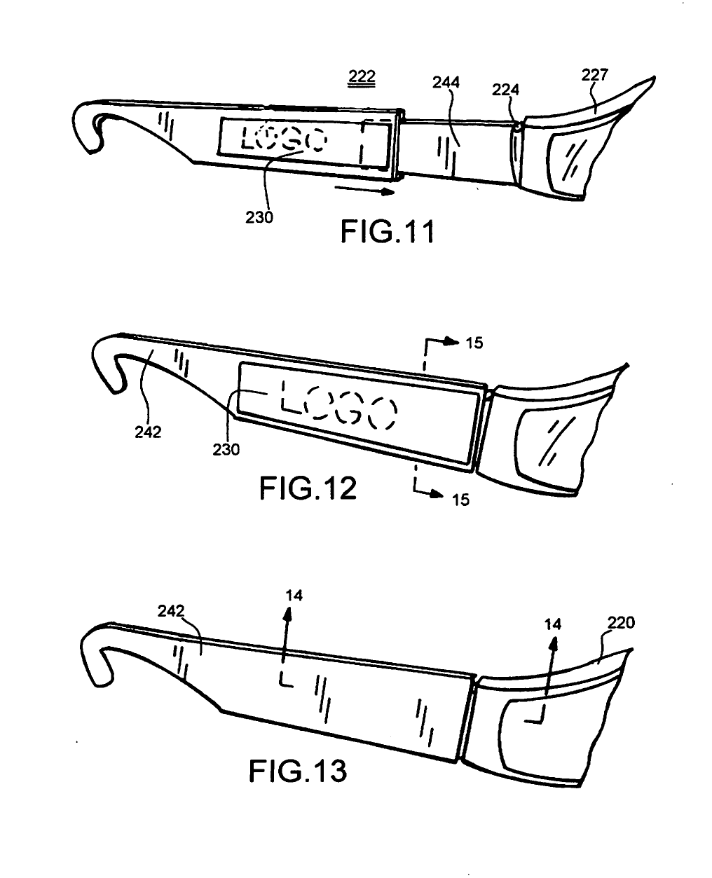

FIG. 11 is a partial assembly perspective view of a further embodiment of the invention in which the temple frame thereof is divided into an earpiece portion and a portion connecting to the eyeglass frame.

FIG. 12 is an assembly view, sequential to that of FIG. 11, showing the complete insertion of the ear portion of the temple frame into a forward position the and, further, showing a decorative surface upon the earpiece portion.

FIG. 13 is an assembly view, similar to that of FIG. 12, however not including a snap fit or selectable decorative portion.

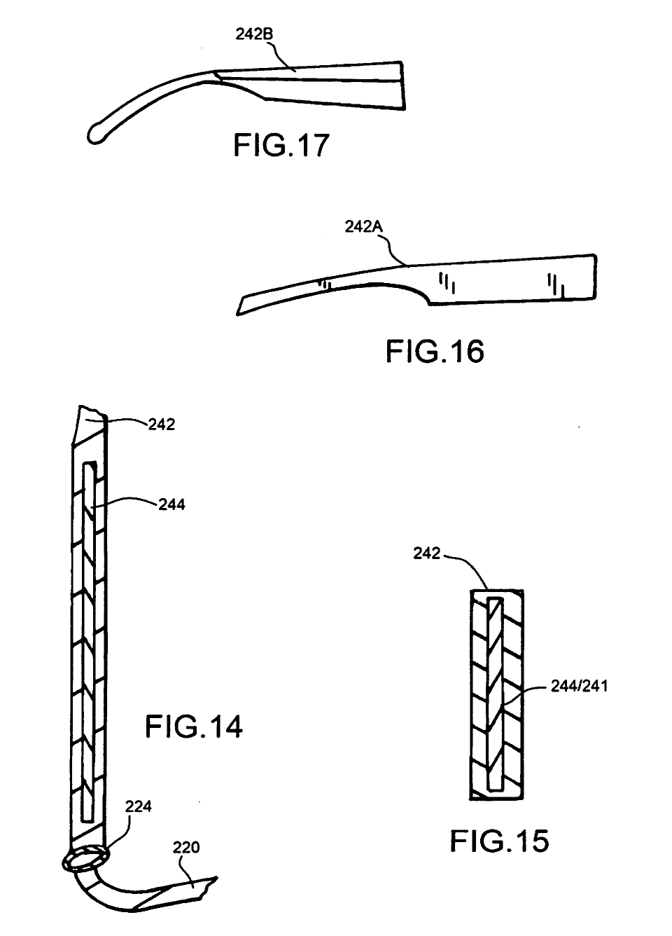

FIG. 14 is a longitudinal cross-sectional view taken through Line 14-14 of FIG. 13.

FIG. 15 is a transverse cross-sectional view taken through Line 15-15 of FIG. 12.

FIG. 16 is a perspective view of a geometry of the temple piece which may be used in lieu of the geometry of the temple piece shown in FIG. 13.

FIG. 17 is a perspective view of a further form that the temple piece of the invention of the present embodiment may assume.

### DETAILED DESCRIPTION OF THE INVENTION

With reference to the exploded view of FIG. 1, a first embodiment of the invention may be seen to include an eyeglass frame 20 and a temple piece 22 which is pivotably connected to the eyeglass frame at a rotational axis 24. As may be appreciated from the geometry of temple frame 22, a portion thereof is provided with a C-shaped channel 26 which acts as a guide or track within which a complemental longitudinal male element 28 of ornamental element 30 may be placed through an opening 31. Said ornamental element is shown in cross-sectional view in FIG. 2. Therefrom, it may be appreciated that male element 28 is proportioned for slidable insertion into C-shaped track 26 of the temple frame 22 while, upon the outer surface of the ornamental element 30 may be provided a logo 32 or any other graphic pattern or icon of interest to the user.

In FIG. 3 is shown a partial insertion of ornamental element 30 into channel 26 of the temple piece 22 and, in FIG. 4 is shown the complete insertion thereinto. Typically, the instant system would be sold with a number of different ornament elements 30 which are reflective of the particular interest of a purchaser of the system. The large size of element 30 relative to the temple piece 22 will adapt it more to use by younger children.

In FIG. 5 is shown a second embodiment of the invention in which ornamental insert 130 differs slightly in cross-section from the geometry of ornamental insert 30 of the embodiment FIGS. 1 through 4. Therein (see FIGS. 5-6) ornamental insert 130 may also be slipped through female opening 131 and into a substantially C-shaped track 126. However, as may be appreciated from the views of FIGS. 8 and 10, the geometry of the ornamental insert differs from the geometry of insert 30 above described, the principal difference being the narrower profile thereof which, it is believed, would be preferred by older users of the instant system in which manual dexterity of the user were not an issue. The system of FIGS. 1-4 would therefore typically be preferred by younger or child-age users than that of the embodiments of FIGS. 5-10.

Further shown in FIGS. 5 and 6 is recess 127 at the earpiece end of channel 126, and which is proportioned or snap-fit axial engagement with end 133 of element 130 after said element is fully inserted, in the manner of a computer flash drive.

FIG. 7 shows insert 130 fully inserted within track 126. Therein, the insert is completely flush with the outer surface 134 of earpiece 123 of temple piece 123 in which openings or aperture 140 (See FIGS. 8 and 9) may be used as a support or grip for icons, patterns or graphics that a user may wish to snap-fit or otherwise apply onto elements 130A, 130B or 130C. See also cross-sectional view of FIG. 10.

With reference to FIGS. 5, 7 and 10, it may be noted that decorative insert 130 includes an upper and lower insert panel 132 which slip over panels 128 of c-shaped track 126 of temple piece 123. Therein, panels 128 are secured between said insert panel 132 and an integral elongate T-shaped member 129 of the insert 130. Therein, back surface 125 of the T-shaped member 129 abuts back surface 123 of the c-shaped track 126.

With reference to the perspective views of FIGS. 11 and 12, there is shown a further, embodiment of the present invention in which a temple piece system 222 includes two distinct portions, namely, an earpiece portion 242 and a forward extension 244 which is pivotally connected to eyeglass frame 220 of the system at a flexible tubular hinge 224 known as a living hinge (see also FIG. 14). I.e., in this embodiment, one earpiece portion 242 may be substituted for different earpiece portions of other geometries or containing different graphics upon the outer surface thereof (more fully described below). As may be noted in FIG. 11 and FIG. 12 (which is sequential to FIG. 4), the earpiece portion 242 includes a longitudinal channel 241 (see FIG. 15) which is substantially complemental in cross-sectional geometry to forward extension 244 of temple piece system 222. Earpiece portion 242, when fully press-fit onto extension 244, will render said portion invisible as may be noted in the view of FIGS. 12 and 13. In other words, the public would, in general, be unaware that the portions 242 and 244 of temple piece 222 are separate from each other, or that forward extension 244 exists.

In comparing FIGS. 12 and 13, one may note that the earpiece portion 242 may optionally be provided with an ornamental or graphic display element 230 which may be either permanently, semi-permanently or snap-fittably affixed to earpiece portion 242. Alternatively, a user may select an earpiece portion, such as earpiece portion 242A shown in FIG. 16, having a completely different geometry than that shown in FIGS. 11-13 and, as well, may select an earpiece portion 242B having a completely different surface or textual appearance, this to coordinate with one's particular dress or other preference. See FIG. 17. That is, a typical user of the embodiment of FIGS. 11-17 will purchase a plurality of different earpiece portions 242, all of which may be compatibly inserted over forward extension 244 of temple piece system 222. This is also shown in the longitudinal cross-sectional view of FIG. 14 which shows the tubular living hinge 224 which may be used in lieu of a traditional mechanical hinge and which enhances the stability of extension 244 relative to eyeglass frame 220.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

I claim:

1. An eyeglass frame system, comprising:
(a) a lens frame;
(b) a pair of temple frames, each inclusive of an earpiece thereof, each having a proximal end pivotally attached to an opposing respective side of said lens frame, at least one member of said pair of temple frames including a longitudinal channel formed within an outer surface thereof, said channel having at least one accessible end thereof; and
(c) a selectable decorative element including an inner portion thereof, said portion complemental in cross-sectional geometry to that of said channel of said temple frame, said selectable decorative element including an outer side upon which an ornamental expression may be applied or integrated.

2. The eyeglass frame system as recited in claim 1, in which said longitudinal channel of said temple frame includes a closed end having an axial geometry complemental to an axial geometry of a first inserted end of said complemental portion of said decorative element, in which the stability of the decorative element, when inserted into said longitudinal channel of the temple frame is enhanced by the securement of said end of said complemental portion of said decorative element into said axial geometry at said closed end of said longitudinal channel.

3. The eyeglass frame system as recited in claim 1, in which is provided on each outer surface of said decorative element includes an aperture to which a decorative icon may be selectable inserted.

4. The eyeglass frame system as recited in claim 1, in which said longitudinal channel of said temple frame comprises, in transverse cross section, a c-shape.

5. The eyeglass frame system as recited in claim 4, in which an outer surface of said decorative element, when inserted into said longitudinal channel of said temple frame, substantially co-planar with an outer surface of said ear portion of the temple frame.

6. The eyeglass frame system as recited in claim 5, in which said complemental portion of said ornamental insert defines a T-shaped geometry complemental to said c-shaped geometry of said channel of said temple frame.

7. An eyeglass frame system comprising:
(a) space lens frame;
(b) a substantially planar side extension pivotally attached at respectively opposite ends of said lens frame;
(c) an integrated earpiece and temple frame, an end opposite to the earpiece portion thereof including an elongate longitudinal channel complemental in cross-sectional geometry to that of said planar side piece attached to said lens frame,
whereby said temple and earpiece frame may be selectably inserted over said side extension.

8. The eyeglass frame system as recited in claim 7, in which said temple and side piece frame comprise a plurality of frames, each differing in geometry or surface effect which, upon selection of an ear and temple frame of interest to the user, may be selectably inserted over said side portion of said system.

9. The eyeglass frame system as recited in claim 7, in which an ornamental surface may be selectably applied to an outer surface of at least one ear and temple piece of the system.

10. A coordinated apparel system comprising a decorative eyeglass frame including:
(a) a lens frame; and
(b) an extension element pivotally connected to each side of said lens frame; and
(c) a temple piece proportioned for press-fittable engagement with said extension element, said piece selected from a plurality of interchangeable temple pieces, each including a selected ornamental feature or geometry.

11. The eyeglass frame system as recited in claim 10, in which said pivotal connection of said extension element to said lens frame comprises a flexible tubular hinge.
